(19) United States
(12) Patent Application Publication
(10) Pub. No.: US 2017/0273844 A1
(43) Pub. Date: Sep. 28, 2017

(54) Patient Isolation Tent

(71) Applicant: Robert Eugene Gillis, Menlo Park, CA (US)

(72) Inventor: Robert Eugene Gillis, Menlo Park, CA (US)

(21) Appl. No.: 15/469,508

(22) Filed: Mar. 25, 2017

Related U.S. Application Data
(60) Provisional application No. 62/313,874, filed on Mar. 28, 2016.

(51) Int. Cl. A61G 10/00

(52) U.S. Cl. CPC A61G 10/005

(57) ABSTRACT

A patient isolation tent is disclosed. The tent includes a free-standing frame assembled from individual frame components and corner connectors. A thin, flexible, substantially transparent, disposable membrane having a bottom surface, four side surfaces, and at least partially open top connects to and is supported by the frame to define a patient isolation space. The membrane is formed as a single, continuous piece of material with integral gloves, interior instrument pockets, and a waste catchment. In use, the bottom surface of the membrane in a collapsed folded or unrolled state overlays a patient support. A patient lays on the support and the side surfaces of the membrane are extended to an upright position to create a patient isolation space. When the patient's isolation period or treatment is completed, the membrane and any patient bodily fluids in the waste catchment are properly disposed of The frame may be disassembled, and the frame and patient support may be reused. The entire patient isolation tent may be provided as a compact kit for ready shipment to and use in remote locations.

### CROSS-REFERENCE TO RELATED APPLICATIONS

This patent application claims the benefit of U.S. Provisional Application No. 62/313,874 filed Mar. 28, 2016, which is incorporated by reference along with all other references cited in this application.

### BACKGROUND OF THE INVENTION

This invention relates to patient isolation tents and similar structures.

Various structures have been proposed to isolate patients with potentially communicable diseases from doctors and other personnel providing medical treatment or other assistance. For example, U.S. Pat. No. 5,061,235 discloses a combination portable stretcher and isolation tent. A patient lies on the stretcher and a frame supports a tent material around the stretcher. The tent material is translucent and collapses in folds around the periphery of the stretcher until unfolded and extended upwardly in use. Sealable portholes or pockets are provided in the tent material for access to the interior.

U.S. Pat. No. 6,241,653 discloses a similar tube-shaped portable patient isolation apparatus with an integral frame structure. In this apparatus, a port is provided to drain fluids from the interior to the exterior of the enclosure. U.S. Pat. No. 3,492,987 discloses a similar patient isolation apparatus for use with a hospital bed and including a pass receptacle and waste container for transferring patient waste from the interior of the enclosure to the exterior.

U.S. Pat. No. 6,461,290 discloses another portable, collapsible patent isolation apparatus with a support base, transparent plastic wall material, and integral support webs or straps. Sealable ports, sleeves, and glove ports are provided for access to the interior of the enclosure. Published U.S. Patent Appl. 2002/0112754 discloses a similar collapsible, self-supporting patient isolation apparatus with a base and transparent enclosure material, which may be stored in a duffle bag when not in use. A capped drain port, access ports, and glove ports are provided in the enclosure material. Published U.S. Patent Appl. 2002/0087045 discloses another similar transparent disposable cover and frame for a patient transport.

A similar patient isolation structure is disclosed in U.S. Pat. No. 7,323,025. In this structure, air holes are provided in a ceiling of the structure for ventilation. Other similar patient isolation structures are disclosed in U.S. Pat. Nos. 3,345,996; 3,272,199; 4,224,936; 7,503,890; 8,007,351; 8,298,130; and Published U.S. Patent Appl. 2002/0087045.

U.S. Pat. No. 4,885,000 proposes a similar structure for isolation and observation of a corpse during a medical procedure. The proposed structure includes a plastic component frame and a translucent sheet supported by the frame. Sealable apertures or port holes are provided in the sheet to allow access to the interior.

U.S. Pat. No. 4,934,396 discloses a portable, disposable decontamination enclosure with a retractable upright frame and a plastic enclosure material which is open at the top and encloses the frame. The enclosure material collapses in folds around the periphery of the frame when not in use. U.S. Pat. No. 4,979,242 discloses a similar collapsible room shelter in which the enclosure material is open at the top and folds in an accordion-like fashion when not in use. U.S. Pat. No. 3,051,163 discloses a similar isolation apparatus with a collapsible frame, but in which the plastic enclosure material is sealed rather than open at the top. U.S. Pat. No. 3,818,896 discloses an inflatable incubator enclosure for an infant in which the enclosure material folds in an accordion-like fashion when not in use. Published U.S. Patent Appl. 2004/0177447 also discloses a patient isolation apparatus in which the enclosure material is foldable in an accordion-like fashion when not in use.

When treating patients with highly communicable diseases it is desirable to provide isolation between the patients and their infected bodily fluids, and medical and other personnel who may be attending them. At the same time, it is desirable to maintain access to the patient in order to provide treatment. When a large number of patients must be treated simultaneously, such as during an outbreak of Ebola, and when the resources and assets available to provide necessary medical treatment are limited, it is further desirable to limit the cost of providing patient isolation.

While a variety of patient isolation and similar structures have been proposed, there remains a need for a patient isolation tent that is inexpensive to construct and ship, easy to assemble and disassemble, disposable, and that provides substantial patient isolation without impairing medical access.

### BRIEF SUMMARY OF THE INVENTION

The present invention resides in a patient isolation tent comprising a frame structure and a membrane for defining an isolated space for a patient. The membrane comprises a single-piece, continuous, flexible and substantially transparent material with a bottom surface, four side surfaces, and an open top. The flexible membrane is collapsible into a compact folded or rolled state and extendable into an erected state. In the erected state, the membrane is attached to and supported by the frame structure without puncturing the membrane material to define the isolated space for the patient. In one aspect of the invention one or more gloves are integrally formed in one or more side surfaces of the membrane. In another aspect of the invention, one or more interior pockets are integrally formed in one or more side surfaces of the membrane. In another aspect of the invention, a waste catchment is integrally formed in the bottom surface of the membrane.

### BRIEF DESCRIPTION OF THE DRAWINGS

FIG. 1 is a perspective view of a preferred embodiment of the patient isolation tent of the invention;

FIG. 2 is a cross-sectional view of the patient isolation tent of FIG. 1 taken along plane 2-2;

FIG. 3 is a perspective view illustrating the membrane of the patient isolation tent of FIG. 1 in a partially collapsed state;

FIG. 4 is a perspective view of a kit comprising an unassembled patient isolation tent of FIG. 1;

FIG. 5 is a perspective exploded view of an alternative embodiment of the membrane 20 of the patient isolation tent of the invention.

### DETAILED DESCRIPTION OF THE INVENTION

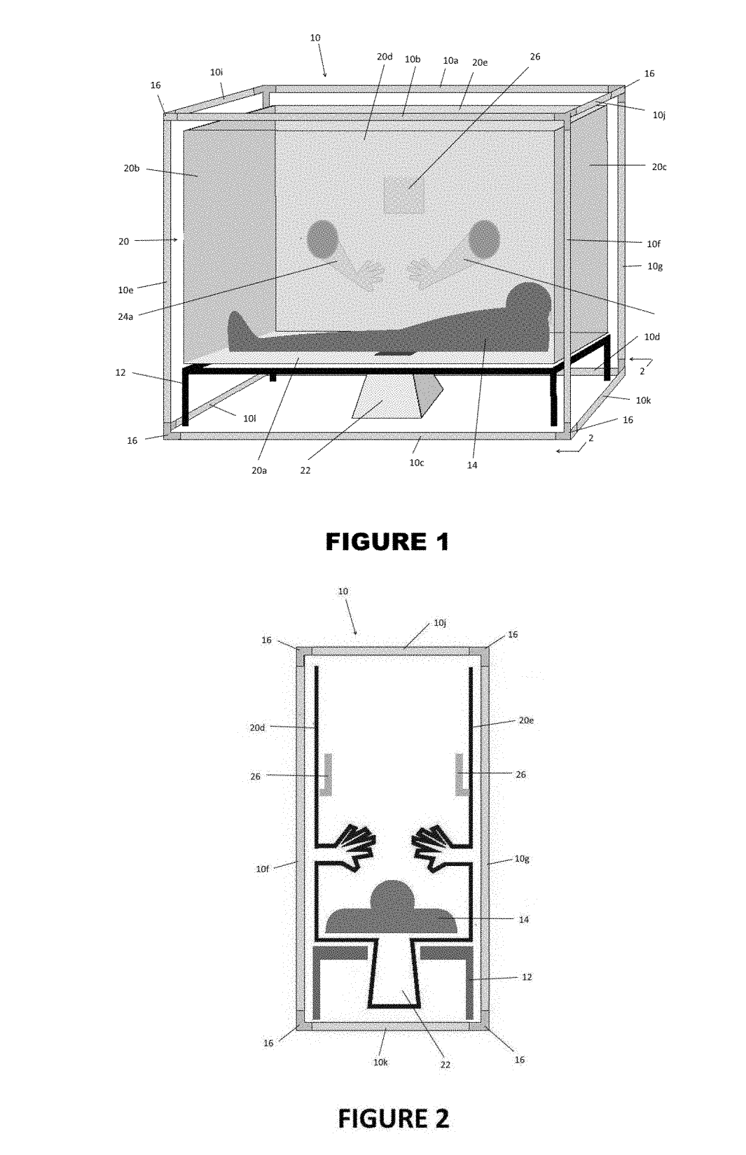

FIGS. 1 and 2 illustrate one preferred embodiment of the patient isolation tent of the invention. In this preferred embodiment, a freestanding frame 10 is comprised of individual frame components 10a-10l. In the illustrated embodiment, the frame 10 is constructed in a substantially rectangular shape with frame components 10a, 10b, 10c, and 10d being substantially the same length and determining the length dimension of the frame, components 10i, 10j, 10k, and 10l being substantially the same length and determining the width dimension of the frame, and components 10e, 10f, 10g, and 10h (not shown in this view), being substantially the same length and determining the height dimension of the frame. Preferably, the frame components are dimensioned to define an interior space with volume sufficient to fully enclose a patient support 12, for example a cot, bed, or stretcher, and a patient 14 supported thereon. In one preferred embodiment, components 10a, 10b, 10c, and 10d are approximately 7 feet, components 10i, 10j, 10k, and 10l are approximately 3 feet, and components 10e, 10f, 10g, and 10h are approximately 6 feet.

Corner pieces 16 located at each corner of the substantially rectangular frame 10 join adjacent frame components securely together at their adjacent ends and provide stability to the frame structure. In a preferred embodiment, the individual frame components 10a-10l and corner pieces are conventional PVC pipes and three-way fittings, such as can be readily purchased at many hardware and home improvement stores. The individual frame components are preferably joined together in the three-way corner fittings via a simple press or friction fit as is conventional with such PVC pipes and fittings. Alternatively or in addition, glue and/or other conventional hardware may be used to strengthen the connections. In a preferred embodiment, the individual frame components and fittings can be standard 1″ PVC pipes and fittings. Such components and fittings have been found to provide sufficient structural rigidity and integrity to be suitable for outdoor use in the elements, while still being relatively light weight and inexpensive. However, if additional structural rigidity is desired or necessary, larger diameter and/or thick-walled PVC pipes and fittings may be used, but with an attendant increase in overall weight. It is understood that materials other than PVC also can be used, consistent with these objectives.

While frame 10 is illustrated in the preferred embodiment of FIGS. 1-2 as being substantially rectangular in shape, persons skilled in the art will understand that the individual frame components can be sized and interconnected to form a frame of any desired shape and size consistent with providing an interior space sufficient to fully contain and isolate a patient supported on a patient support and to allow suitable access to the patient by medical and other attendants, as further described herein. For example, a suitable frame can be constructed in a dome or other shape, many of which are well known in the art related to patient isolation structures. Similarly, while each of the individual frame components 10a-10l is shown as being a single piece, it is understood that any or all of the individual components alternatively can be formed from multiple pieces joined together using appropriate fittings or the like. For example, for ease of handling or for packing and shipping considerations, 7 foot components could be constructed of two 3.5 foot components joined by a fitting.

Similarly, while frame 10 is shown as a free-standing structure resting on a base or the ground, it is understood that the frame also could be supported by straps or other conventional connectors to other structures, such as the rafters of a building, etc.

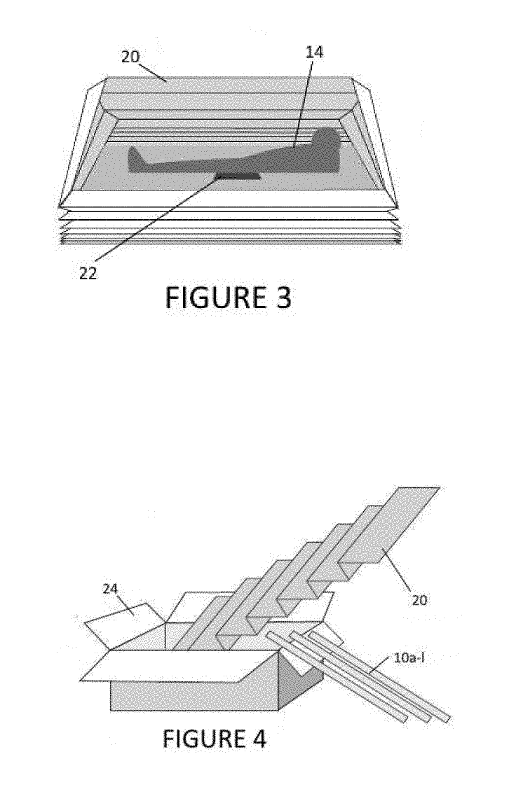

As shown in FIGS. 1-3, a flexible, foldable or collapsible membrane 20 has a bottom surface 20a and side surfaces 20b, 20c, 20d, and 20e. The top of the membrane 20 is preferably partially or completely open. Prior to use, the membrane 20 is preferably in a collapsed rolled or folded state. For example, as shown in FIG. 3, the membrane 20 can be formed with folds or pleats such that it can be folded down in an accordion-like fashion. In the collapsed rolled or folded state, the bottom surface 20a can be laid over a patient support 12 within the space defined by frame 10. A patient 14 can then lay on the support 12 atop the bottom surface 20a of the membrane so that the bottom surface 20a of the membrane is between the patient 14 and the patient support 12 and isolates the support from the patient. If desired, a porous mat or other material or layer (not shown) may be inserted between the patient and the bottom surface of the membrane to improve the comfort of the patient and to facilitate drainage of fluids from the patient while maintaining isolation of the patient and fluids within the membrane.

As best shown in FIGS. 1-2, once a patient 14 is supported on the patient support 12, the side surfaces 20b, 20c, 20d, and 20e of the membrane may be unrolled or unfolded into an extended upright position. In the extended position, the membrane defines an isolated space surrounding the patient 14. In the extended position, the membrane 20 is preferably attached to the frame without puncturing the membrane. This is readily accomplished using commercially-available connectors such as Grip-Clip® brand connectors sold by Shelter-Systems LLC of Menlo Park, Calif. The side surfaces 20b, 20c, 20d, and 20e of the membrane may be attached at or near their top edges to the frame components 10a, 10b, 10i and 10j using GripClip® or other suitable non-puncturing fasteners at as many or as few locations as desired to support the side surfaces in their extended upright positions. Also suitable for use are non-puncturing connectors as described in U.S. Pat. Nos. 4,308,647 and 6,718,600 and pole connectors such as described in U.S. Pat. No. 6,279,208, each of which is incorporated herein by reference. Alternatively, the side surfaces can be dimensioned to loop over the tops of the frame components 10a, 10b, 10i , and 10j and then be connected to either the top frame components, themselves, or both. Similarly, the side surfaces 20b, 20c, 20d, and 20e may be connected to other frame components such as upright components 10e, 10f, 10g, and 10h if desired or necessary to support the membrane and/or maintain the volume of the isolated space. The bottom surface 20a may be connected in similar fashion to the patient support and/or frame components to further increase stability by locking the membrane, cot, and frame together. Tensioning members (not shown), such as nylon cords or straps, are preferably provided extending between the GripClip® or other non-puncturing connectors and the frame components to impart tension to the membrane surfaces. The tensioning members can help maintain the volume of the isolated space and improve the rigidity of the overall structure. Also similarly, if desired or necessary, the bottom surface 20a of the membrane may be similarly connected to the patient support 12.

When a patient's isolation period or treatment is completed, the isolation tent is easily disassembled by removing the attachment clips, rolling or folding the sides of the membrane into the collapsed position, and safely disposing of the membrane and any bodily fluids contained therein by incineration or otherwise. The frame is readily disassembled by manually removing the ends of the frame components from the corner connectors. The frame components and the patient support may be stored and reused since they were not exposed to the patient or the patient's bodily fluids.

As best shown in FIGS. 1-2, the membrane 20 is preferably formed in a shape and with dimensions such that in its extended upright state it fits within the space defined by frame 10 and itself defines an isolated space of sufficient volume to fully enclose and isolate patient 14 supported on patient support 12. As with frame 10, however, it is understood that while membrane 20 is illustrated in the preferred embodiment of FIG. 1 as being substantially rectangular in shape, consistent with the preferred shape of frame 10, the membrane may be formed in various other shapes as desired, depending on the shape of the frame and consistent with the objectives of providing sufficient isolation space for the patient and sufficient access to the patient for medical and other personnel. For example, the membrane could be formed in the shape of an open-top dome, cylinder, or cone.

In a preferred embodiment, one or more pairs of glove ports and gloves 24a, 24b are integrally formed in one or more membrane sidewalls 20b, 20c, 20d, and 20e to enable medical and other personnel to provide care and assistance to a patient without being exposed to the patient or the patient's bodily fluids. One or more pockets 26 also may be formed in the interior surfaces of the membrane side walls to provide storage for medical instruments, tools, or the like. With the top of the membrane partially or completely open, medical and other personnel have the ability to introduce instruments into the pockets without being exposed to the patient, for example by using a pole and line to lower instruments into the pockets.

Also in a preferred embodiment, a waste catchment or pocket 22 is integrally formed in the membrane bottom surface 20a with an opening in a location to facilitate collecting patient bodily fluids. The opening for the waste catchment is preferably located in coordination with an opening in the patient support 12 and any mat or pad lying thereon to facilitate the drainage of fluids away from the patient. In addition, if desired, the patient support and/or mat may be sloped or otherwise shaped to facilitate the flow or drainage of fluids away from the patient and into the waste catchment opening. Because the waste catchment and opening are integrally formed with the membrane bottom surface, the risk of a patient's bodily fluids escaping the isolation space through a seam or otherwise and possibly infecting medical and other personnel is greatly reduced. The waste catchment may be supported below the patient support on a base or on the ground and may be sized to accommodate an expected amount of bodily fluids based on the illness being treated, the patient, and the expected duration of isolation. In an alternative embodiment, the membrane bottom surface may lie directly on the ground rather than on a patient support. In that embodiment, a hole may be dug in the ground below the patient and the waste catchment supported in the hole.

The membrane is preferably formed of a thin, flexible, substantially transparent plastic material that is substantially impermeable to a patient's bodily fluids. While the membrane need not be completely transparent, it is preferred that the membrane be at least sufficiently transparent to provide medical and other personnel sufficient visibility into the isolated space to provide treatment and other assistance to a patient. It is also preferred that the membrane material be inexpensive and light-weight, making it economically-feasible to manufacture and ship, as well as to dispose of following use. Various conventional plastic materials are known to have these qualities, including various polyethylene and polyvinylchloride materials. In practice, 4 mil thick material has been found suitable, but thicker or thinner material may be used as desired consistent with the objectives described above, and with providing sufficient resistance to rupturing or puncturing in expected uses.

In one preferred embodiment the membrane is formed as a single, continuous piece of material by a conventional blow molding or similar process. Forming the membrane in this fashion reduces the risk of infected fluids from a patient escaping the isolated space, possibly through a seam or sealable opening in the membrane, and possibly infecting medical or other personnel attending to the patient. Forming the membrane by such a process also facilitates the proper disposal of the entire membrane, together with any patient bodily fluids in the waste catchment, by incineration or otherwise when the patient's isolation period or treatment is completed. This further reduces the risk of medical and other personnel becoming infected by inadvertent exposure to a patient's infected bodily fluids.

In this embodiment, the mold used for blow molding can be designed to produce a pre-folded membrane in which the upper portion of the membrane extending above the patient support and the lower waste catchment portion are molded in a folded shape, such as an accordion shape with molded in pleats as illustrated in FIG. 3. Producing the membrane this way can reduce cost by substantially reducing the thickness and hence overall size of the required mold. Another advantage is that the membrane is produced in a pre-folded state ready for packaging, shipment, and deployment right out of the mold, thus reducing manual labor costs.

Also in this embodiment, the mold can be formed so that, in addition to the gloves, pockets and waste catchment described above, a flow-contoured bed mat can be integrally molded with the bottom surface of the membrane in a location to overlie the patient support. Thus, in this embodiment, the entire patient isolation tent, less frame components and connectors, can be provided in one piece. Producing the entire membrane as a single piece in this way reduces cost and further facilitates packaging, shipping, and deployment in the field.

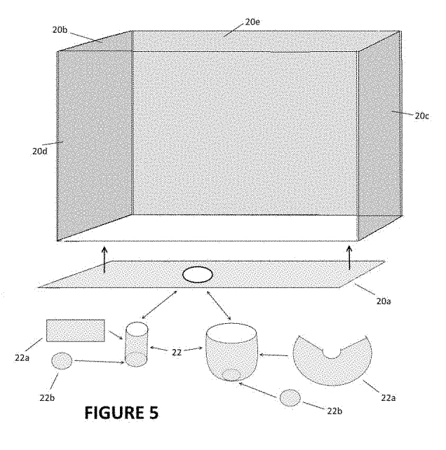

FIG. 5 illustrates an alternative embodiment of the membrane 20 in which the sidewalls 20b, 20c, 20d, and 20e and the bottom surface 20a are individually formed, preferably by blow molding or a similar process, and then continuously joined at their adjacent edges, for example by heat-welding or a similar process. In this alternative, the adjacent edges of the adjacent sidewalls and/or bottom surface are dimensioned to overlap slightly, and the heat welding or other joining process creates a continuous seal (illustrated by dashed lines) along the adjacent edges which is impermeable to fluids. Although only one seal is illustrated, it will be appreciated that the weld or other joining process may be applied to one or more locations along the adjacent edges to ensure complete isolation and to strengthen the seal as desired or necessary. In this alternative, the waste catchment 22 also can be separately formed from the bottom surface and joined to it via a similar heat welding or other joining process applied along adjacent edges. In this alternative, the waste catchment 22 also can be formed as two separate pieces 22a and 22b joined together and joined to the bottom of the bottom surface by a similar heat welding or other process along adjacent edges. In this alternative, piece 22a is preferably a flat piece of membrane material, which may be rolled or otherwise formed into a substantially cylindrical, conical, trapezoidal, bowl, or other shape. For example, piece 22a may be formed as an elongated rectangle and rolled into a substantially cylindrical shape. Alternatively, piece 22a may be formed as a toroid and rolled or otherwise manipulated into a substantially bowl-like, conical, or trapezoidal, shape. In either instance, an opening in piece 22a is preferably formed and positioned below the opening in the bottom surface 20a when joined to the bottom piece. In this way, the waste catchment 22 is securely sealed both internally and to the bottom of the bottom surface 20a of membrane 20. Gloves 24 and pockets 26 (not shown in FIG. 5) also can be separately formed as a single flat piece or multiple flat pieces of membrane material and similarly joined together and to the sidewalls of the membrane.

Either embodiment of the patient isolation tent can be readily tested for pathogen impermeability by securely closing the membrane opening with an airtight cap or the like and using an air hose or the like to apply pressure within the membrane. Pressure leakage can be easily determined similarly to checking a bike tire for leakage by spraying the outer surfaces of the membrane with a solution of diluted solution of soap water and looking for air bubbles.

Referring to FIG. 4, a beneficial aspect of the preferred embodiment is that a complete patient isolation tent, for example an embodiment as shown in FIG. 1, including a frame 10 assembled from individual frame components 10a-10i and corner connectors (not shown), a collapsible membrane 20, and connectors (not shown) can be provided as a light-weight and compact kit. In kit form, the patient isolation tent can be easily and inexpensively shipped in a relatively small box 24 to remote locations where needed.

The foregoing description of exemplary embodiments of the invention has been presented for purposes of illustration and description. It is not intended to be exhaustive or to limit the scope of the invention to the precise examples shown and described. Many modifications and variations to the exemplary embodiments are possible in accordance with the principles of the invention and will be apparent to persons of ordinary skill in the art in light of the teachings herein. The scope of the invention is defined by the following claims.

The invention claimed is:

1. A patient isolation enclosure comprising:
a frame;
a membrane formed of a single continuous piece of flexible plastic material and having a plurality of sides and a bottom, said membrane being attached to said frame and defining an isolation space for a patient, said isolation space completely enclosed by said membrane except for a top opening; and
a waste catchment integrally formed in said bottom of said membrane and having an opening for receiving patient bodily fluids, said waste catchment retaining said patient bodily fluids within said isolation space.

2. The patient isolation enclosure of claim 1, including a glove port integrally formed in a side of said membrane for allowing access within said isolation space from outside said isolation space.

3. The patient isolation enclosure of claim 1, including a storage pocket integrally formed in a side of said membrane and accessible within said isolation space.

4. The patient isolation enclosure of claim 1 wherein said membrane is attached to said frame by a plurality of tensioning members.

5. The patient isolation enclosure of claim 1 wherein said frame defines an interior space having a selected shape and a volume sufficient to contain said isolation space and a patient support.

6. The patient isolation enclosure of claim 5 wherein said frame and said patient support are external to said isolation space and are isolated from said isolation space by said membrane.

7. The patient isolation enclosure of claim 6 wherein said bottom of said membrane is in contact with said patient support whereby said patient support remains isolated from said isolation space while supporting a patient contained within said isolation space.

8. The patient isolation enclosure of claim 7 wherein said patient support has an opening for said waste catchment, whereby bodily fluids of a patient on said patient support may be communicated from said patient to said waste catchment.

9. The patient isolation enclosure of claim 1 wherein said membrane sides are extendable between a collapsed state for allowing patient access to said isolation space and an extended state for enclosing said patient within said isolation space.

10. The patient isolation enclosure of claim 9 wherein said membrane sides have pre-formed folds therein to facilitate movement between said collapsed and extended states.

11. The patient isolation enclosure of claim 1 wherein said membrane comprises an at least partially transparent plastic material that is substantially impermeable to patient bodily fluids.

12. The patient isolation enclosure of claim 11 wherein said membrane is formed of blow molded membrane material selected from one of a polyethylene or polyvinylchloride membrane material.

13. The patient isolation enclosure of claim 1 wherein said frame comprises an assembly of individual frame components and fittings.

14. The patient isolation enclosure of claim 13 wherein said individual frame components and fittings are dimensioned so as to fit in a compact package when said frame is disassembled.

15. The patient isolation enclosure of claim 13 wherein said individual frame components comprise sections of relatively rigid plastic pipe.

16. A patient isolation enclosure comprising:
a frame;
a membrane of a blow-molded plastic material, said membrane being relatively thin and flexible, substantially impermeable to bodily fluids, and at least partially transparent;
said membrane being attached to said frame and defining an isolation space, said isolation space completely enclosed by said membrane except for an opening to admit a patient;
a waste catchment integrally formed in said membrane and having an opening for receiving patient bodily fluids, said waste catchment retaining said patient bodily fluids within said isolation space; and
a glove port integrally formed in said membrane for allowing access to a patient within said isolation space from outside said isolation space without exposure to said patient bodily fluids.

17. The patient isolation enclosure of claim 16 including a patient support, said patient support external to and underlying said isolation space, and separated therefrom by said membrane, said patient support for supporting a patient within said isolation space.

18. The patient isolation enclosure of claim 17 wherein said patient support has an opening for said waste catchment, whereby bodily fluids of a patient on said patient support may be communicated from said patient to said waste catchment.

19. The patient isolation enclosure of claim 16 wherein said membrane has prefolds formed therein to facilitate extending said membrane from a compact folded state for storage and shipment, to an extended state for defining an isolation space for containing a patient when in use.

20. The patient isolation enclosure of claim 17 wherein said frame is comprised of a plurality of individual frame components and fittings dimensioned to fit in a compact package in a disassembled state for storage and shipment, and in an assembled state to form said frame defining an interior space having a selected shape and a volume sufficient to contain said isolation space and said patient support.
